(19) United States
(12) Patent Application Publication
(10) Pub. No.: US 2014/0091148 A1
(43) Pub. Date: Apr. 3, 2014

(54) RADIO FREQUENCY IDENTIFICATION MODULE

(71) Applicant: SMART APPROACH CO., LTD., Hsinchu (TW)

(72) Inventors: Hsin-Lung Lin, Hsinchu (TW); Ming-Chung Lin, Hsinchu (TW)

(73) Assignee: SMART APPROACH CO., LTD., Hsinchu (TW)

(21) Appl. No.: 13/693,867

(22) Filed: Dec. 4, 2012

(30) Foreign Application Priority Data
Sep. 28, 2012 (TW) 101218891

(51) Int. Cl. G06K 19/07

(52) U.S. Cl. CPC G06K 19/0723
USPC 235/492

(57) ABSTRACT

AN RFID module includes a substrate, an antenna coil, an identification module, and multiple connection points. The antenna coil is placed on the substrate. The identification module is disposed on the substrate and within a predetermined region surrounded by the antenna coil. The identification module is electrically connected to the antenna coil. The connection points is disposed on the substrate and electrically connected to the identification module.

### CROSS-REFERENCE TO RELATED APPLICATIONS

This non-provisional application claims priority under 35 U.S.C. §119(a) on Patent Application No(s). 101218891 filed in Taiwan, R.O.C. on Sep. 28, 2012, the entire contents of which are hereby incorporated by reference.

### BACKGROUND

1. Technical Field

The disclosure relates to a radio frequency identification (RFID) module, and more particularly, to an RFID module in a reduced size.

2. Related Art

With the wireless transmission technology advancing, subscriber identity modules (SIM) of handheld electronic devices are beginning to have an RFID-related technology integrated. Architecture of the RFID-related technology mainly includes a reader, a transponder and a middleware/system integration. When the RFID-related technology is integrated with the SIM of the handheld electronic devices, the handheld electronic devices are enabled to have the RFID capability.

The reader includes a signal processing unit and a wireless communication unit. The signal processing unit is for processing signals to be received and delivered, while the wireless communication unit is for transmitting (receiving and delivering) the signals. The transponder includes an electronic chip and an antenna. The electronic chip accesses the signals while the antenna is used to wirelessly receive and deliver the signals. The reader can emit an radio in a predetermined frequency to the transponder, and the transponder could receive the emitted radio through the antenna, and then the radio is converted to a corresponding current signal to drive a circuit of the electronic chip to return the information inside the chip such that the information is received by the reader.

The middleware/system integration is a software design configured to interface human operators and the reader for enabling the information received by the reader to be properly collected, processed, and presented to the human operators. Therefore, when the antenna, that is RFID-enabled, and an identification chip is electrically connected to each other, the identification chip could access the information (or identification information) in the SIM before transmitting the same information to the reader such that the SIM is RFID-enabled.

Conventionally, upon the SIM being installed into the handheld electronic device, the identification information of the SIM could be transmitted to an external reader after an internal chip of the handheld electronic device successfully communicates with the reader. In other words, the conventional SIM could only be unilaterally identified, which is not able to function as the reader to identify devices external to the SIM such as a smart card. Moreover, the electronic chip in the conventional transponder is placed outside a region surrounded by the antenna, which increases the size of the transponder.

### SUMMARY

The disclosure provides an RFID module comprising a substrate, an antenna coil, an identification module, and multiple connection points. The antenna coil is disposed on the substrate. The identification module is disposed on the substrate and in a predetermined region surrounded by the antenna coil. The identification module is electrically connected to the antenna coil. The connection points are disposed on the substrate and electrically connected to the identification module.

### BRIEF DESCRIPTION OF THE DRAWINGS

The disclosure will become more fully understood from the detailed description given herein below for illustration only, and thus is not limitative of the disclosure, and wherein:

FIG. 1 is a top view of an RFID module according to the first embodiment of the disclosure;

FIG. 2 is a bottom view of the RFID module in FIG. 1 according to the first embodiment of the disclosure;

FIG. 3 is a schematic diagram of a bus of the RFID according to one embodiment of the disclosure;

FIG. 4 is a top view of an RFID module according to the second embodiment of the disclosure;

FIG. 5 is a bottom view of the RFID module in FIG. 4 according to the second embodiment of the disclosure;

FIG. 6 is a top view of an RFID module according to the third embodiment of the disclosure;

FIG. 7 is a bottom view of the RFID module in FIG. 6 according to the third embodiment of the disclosure;

FIG. 8 is a top view of an RFID module according to the fourth embodiment of the disclosure; and

FIG. 9 is a bottom view of the RFID module in FIG. 8 according to the fourth embodiment of the disclosure.

### DETAILED DESCRIPTION

The detailed features and advantages of the disclosure are described below in great detail through the following embodiments, the content of the detailed description is sufficient for those skilled in the art to understand the technical content of the present disclosure and to implement the disclosure there accordingly. Based upon the content of the specification, the claims, and the drawings, those skilled in the art can easily understand the relevant objectives and advantages of the disclosure.

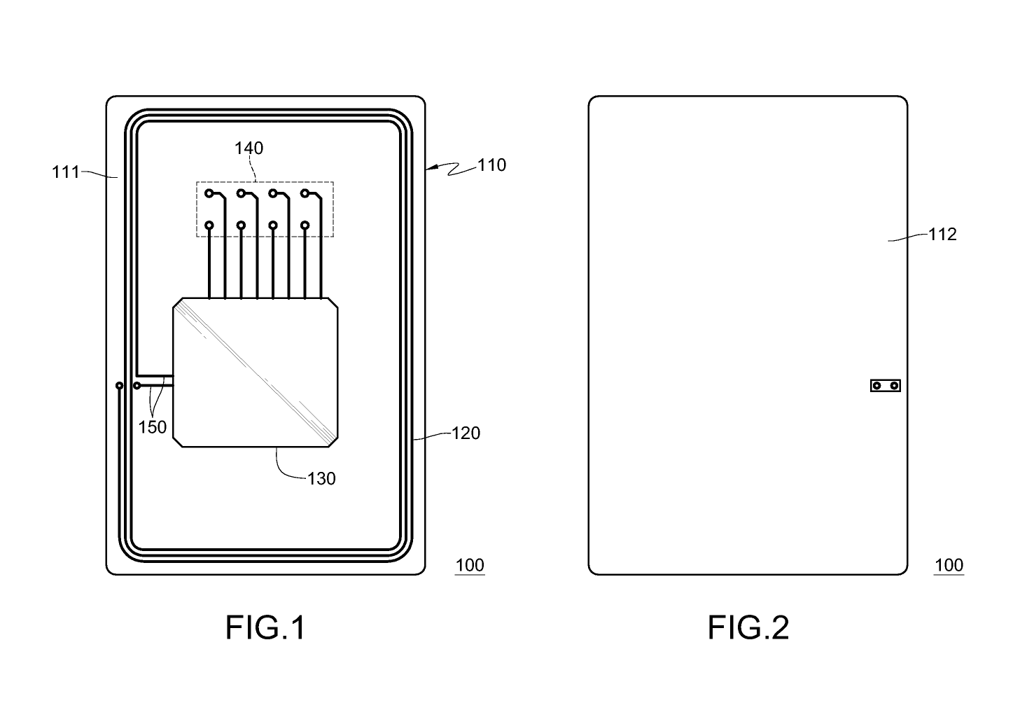

Please refer to FIGS. 1 and 2, which are a top view and a bottom view of a radio frequency identification (RFID) module 100 according to the first embodiment of the disclosure, respectively. The RFID module 100 may be placed into a cellular phone, a laptop/notebook, a portable application description (PAD) device, an RF-related device, or a near-field communication device for facilitating the RFID-based communication or enhancing the near-field communication.

The RFID module 100 comprises a substrate 110, an antenna coil 120, an identification module 130, and multiple connection points 140. In this embodiment, the substrate 110 may be a flexible substrate, i.e., a flex printed circuit board (FPC).

The antenna coil 120 is disposed on the substrate 110 in a printed manner. The antenna coil 120 may be an RF-based antenna or a near-field communication antenna.

The identification module 130 is disposed on the substrate 110 and placed in a predetermined region of the substrate 110. The predetermined region is surrounded by the antenna coil 120. The substrate 110 has a first surface 111 and a second surface 112. The first surface 111 and the second surface 112 are opposite to each other. The identification module 130 may be disposed on either the first surface 111 or the second surface 112. In this embodiment, the identification module 130 may be an RFID chip and formed on the substrate 110 (on either the first surface 111 or the second surface 112 of the substrate 110) by a manufacturing process, i.e., chip on board (COB) process or chip in film (CIF) process, but does not limit the disclosure.

The connection points 140 are disposed on the substrate 110. In this embodiment, the connection points is disposed on the first surface 111 of the substrate 110 and electrically connected to the identification module 130. In this embodiment, the connection points are be Pogo pin pads, but not limited to the disclosure.

Furthermore, the connection points 140 may be placed within the predetermined region surrounded by the antenna coil 120 and arranged between the antenna coil 120 and the identification module 130. However, the positions of the connection points 140 may vary from embodiment to embodiment as long as the connection points 140 are within the above-mentioned predetermined region surrounded by the antenna coil 120 and between the antenna coil 120 and the identification module 130, these positions of the connection points 140 are included according to the embodiments of the disclosure.

The connection points 140 is adapted to be connected to a power pin, a ground pin, a data transmission pin, and a signal input/output pin, of a control chip of a handheld electronic device (not shown). Moreover, the number of the connection points 140 may vary depending on the number of the pins in the control chip, despite eight connection points 140 being shown in FIG. 1. For example, assume the control chip has one power pin, one ground pin, three data transmission pins (i.e., (inter integrated circuit) I2C SDA pins, I2C SCL pin, and one SIM card connection pin), and two signal input/output pins (such as IRQ pin and GPIO4 pin), the total number of the connection points 140 is 7, each of the pins may correspond to its corresponding pin of the control chip.

Plus, assume the control chip includes one power pin, one ground pin, and two data transmission pins (for example, universal serial bus (USB) pins such as USB+ and USB− pins), the number of the connection points 140 is 4, ensuring the one-to-one relationship between the connection points 140 and the pins of the control chip could be maintained.

Moreover, the RFID module 100 comprises a connection wire 150 which is disposed on the substrate 110. The connection wire 150 is adapted to facilitate the electrical connection between the antenna coil 120 and the identification module 130. In this embodiment, a part of the connection wire 150 is located on the second surface 112 of the substrate 110 and is connected to the connection wire on the first surface 111 as well as the second surface 112 through a perforation penetrating the substrate 110.

The antenna coil 120 is adapted to receive a radio signal from an RFID reader, convert the radio signal to a first current signal, and transmit the first current signal to the identification module 130 through the connection wire 150. Also, the antenna coil 120 is adapted to receive a second current signal transmitted from the identification module 130, convert the second current signal to another radio signal, and transmit another radio signal to the RFID reader wirelessly.

In other words, when the RFID module 100 receives a command from the incorporated into the cellular phone, the identification module 130 transmits the first current signal, which may be converted to the radio signal by the antenna coil 120 and transmitted to an external identification chip, such as a smart card. Also, the RFID module may also receive the radio signal from the external identification chip, convert the radio signal into the second current signal, and transmit the second current signal to the identification module 130, which may be further converted into a digital signal. Next, the digital signal may be further returned to the cellular phone, and therefore the RFID module may function as the RFID reader.

The arrangement provided in the disclosure may effectively reduce the size of the RFID module, reduce the antenna loss, and enable the processing unit of the cellular phone to read the information stored in the external identification chip, and enable the external identification chip to read the information stored in the identification module of the RFID module.

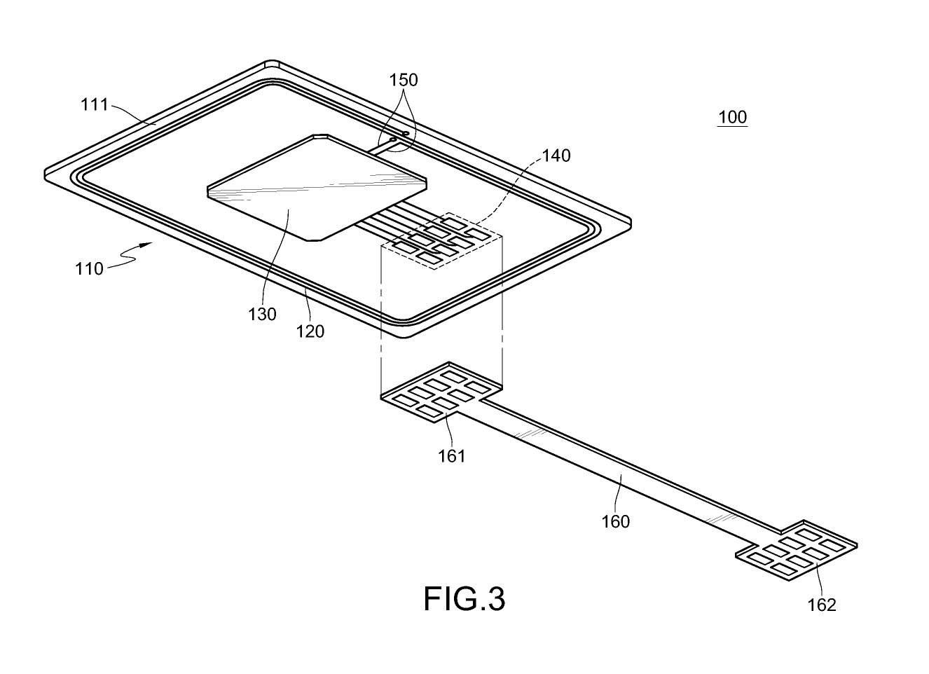

In another embodiment, the RFID module 100 further comprises a bus 160 in FIG. 3. The bus 160 includes a first end 161 and a second end 162. The first end 161 of the bus 160 is connected to the connection points 140, while the second end 162 of the same bus 160 is connected to the power pin, the ground pin, the data transmission pin, and the signal input/output pin, of the control chip of the handheld electronic device. That is to say, in this embodiment, the RFID module 100 comprises fixed pins disposed at the second end 162 of the bus 160 for electrically connecting the connection points 140 to the control chip. In another embodiment, the RFID module 100 comprises so-called gold fingers disposed at the second end 162 of the bus 160 for electrically connecting the connection points to the control chip.

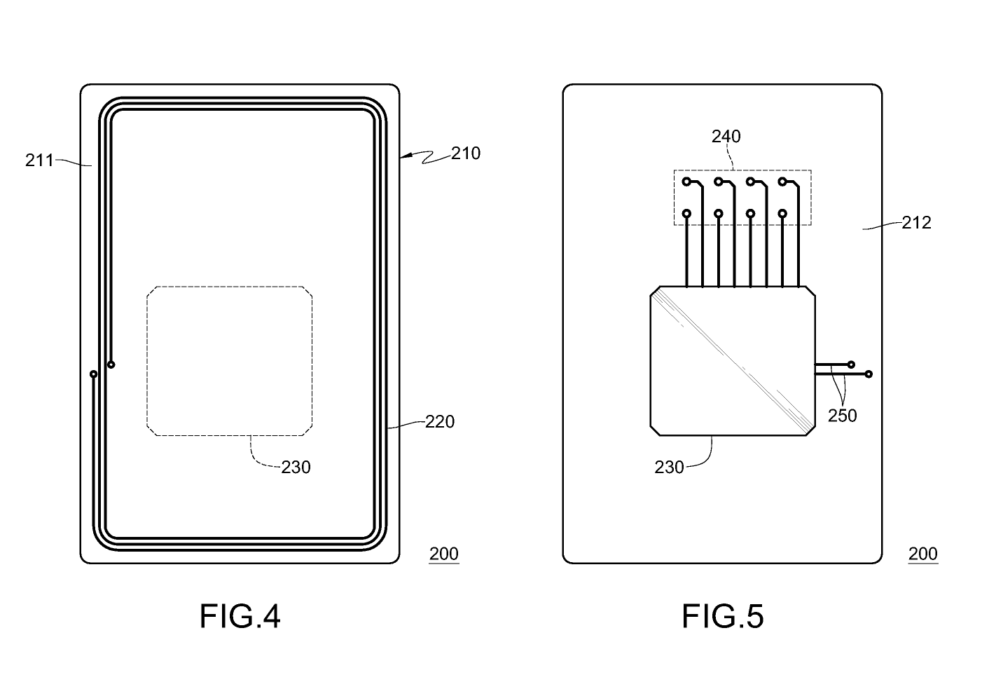

Please refer to FIGS. 4 and 5, which are a top view and a bottom view of an RFID module according to the second embodiment of the disclosure, respectively. An RFID module 200 comprises a substrate 210, an antenna coil 220, an identification module 230, multiple connection points 240 and a connection wire 250. Structures of the substrate 210, the antenna coil 220, the identification module 230, the connection points 240, and the connection wire 250 may be the same as their counterparts in FIGS. 1 and 2, so the similarities are not repeated again. Similarly, the RFID module 200 also comprises the same bus shown in FIG. 3 so that the connections points 240 are electrically connected to the control chip of the handheld electronic device through the bus, and the similarities are not repeated, either.

In this embodiment, the substrate 210 includes a first surface 211 and a second surface 212 which are opposite to each other. The antenna coil 220 is disposed on the first surface 211 of the substrate 210, while the identification module 230, the connection points 240, and the connection wire are all disposed on the second surface 212 of the substrate 210. The identification module 230 and the connection points 240 are both located within a predetermined region defined and surrounded by the antenna coil 220. The connection wire 250 is electrically connected to the antenna coil 220 through perforations penetrating the substrate 210, allowing for the antennal coil 220 to be in electrical connection with the identification module 230. Although the arrangement of this embodiment is slightly different from that of the first embodiment, this embodiment may also achieve the same function in the first embodiment.

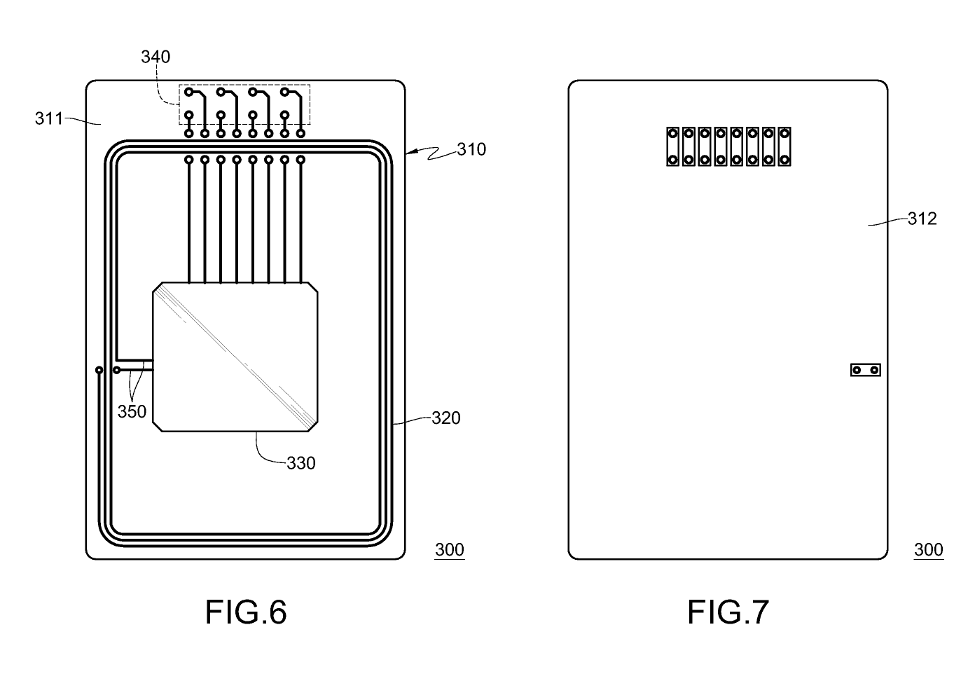

Please refer to FIGS. 6 and 7, which are a top view and a bottom view of an RFID module according to the third embodiment of the disclosure. AN RFID module 300 comprises a substrate 310, an antenna coil 320, an identification module 330, multiple connection points 340 and a connection wire 350. Structures of the substrate 310, the antenna coil 320, the identification module 330, the connection points 340 and the connection wire 350 may be the same as their counterparts in FIGS. 1 and 2, so the similarities are not repeated again. Similarly, the RFID module 300 also comprises the same bus shown in FIG. 3 so that the connections points 340 are electrically connected to the control chip of the handheld electronic device through the bus. The structure and the use of the bus may be referred to the first embodiment in FIG. 3, so the similarities are not repeated, either.

In this embodiment, the substrate 310 includes a first surface 311 and a second surface 312 which are opposite to each other. The antenna coil 320, the identification module 330, the connection points 340, and the connection wire 350 are all disposed on the first surface 311 of the substrate 310 while the connection points 340 are disposed outside a predetermined region surrounded by the antenna coil 320. A part of the connection wire 350 is disposed on the second surface 312, and another part of the connection wire 350 disposed on the first surface 311 is electrically connected to the other part of the connection wire 350 through perforations which penetrates the substrate 310. The connection part between the identification module 330 and the connection points 340 is disposed on the second surface 312, and the identification module 330 and the connection points 340 are electrically connected to each other through another perforations which penetrates the substrate 310 as well. Consequently, both of the part of the connection wire 350 as well as the connection part between the identification module 330 and the connection points 340 may not be in the electrical connection with the antenna coil 320 such that the signal transmission of the antenna coil 320 may not be interfered. Although the arrangement of this embodiment is slightly different from that of the first embodiment, this embodiment may also achieve the same function in the first embodiment.

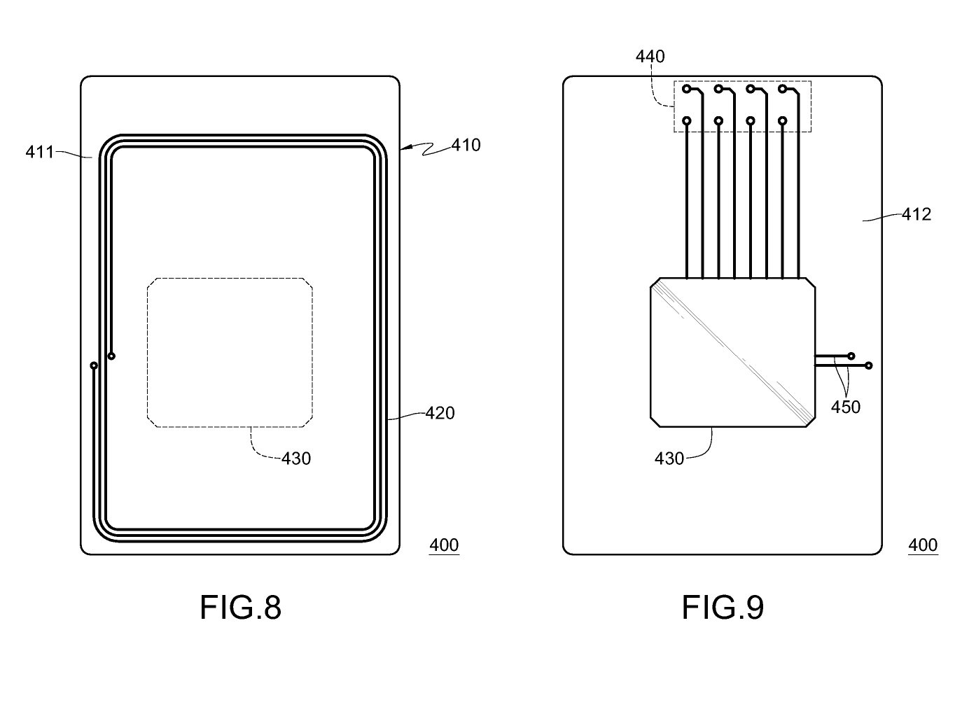

Please refer to FIGS. 8 and 9, which are a top view and a bottom view of an RFID module according to the fourth embodiment of the disclosure, respectively. AN RFID module 400 comprises a substrate 410, an antenna coil 420, an identification module 430, multiple connection points 440 and a connection wire 450. Structures of the substrate 410, the antenna coil 420, the identification module 430, the connection points 440 and the connection wire 450 may be the same as their counterparts in FIGS. 1 and 2, so the similarities are not repeated again. Similarly, the RFID module 400 also comprises the same bus shown in FIG. 3 so that the connection points 440 are electrically connected to the control chip of the handheld electronic device through the bus. However, the structure and the use of the bus may refer to the first embodiment in FIG. 3, so the similarities are not repeated, either.

In this embodiment, the substrate 410 includes a first surface 411 and a second surface 412 which are opposite to each other. The antenna coil 420 is disposed on the first surface 411 of the substrate 410, and the identification module 430, the connection points 440, and the connection wire 450 are all disposed on the second surface 412 of the substrate 410. The connection points 440 are disposed outside a predetermined region surrounded by the antenna coil 420. The connection wire 450 penetrates through perforations of the substrate 410 for electrically connecting the identification module 430 and the antenna coil 420. Although the arrangement of this embodiment is slightly different from that of the first embodiment, this embodiment may also achieve the same function in the first embodiment.

Moreover, the RFID modules 100-400 may be controlled by a software program and may operate in a reader mode or a transponder mode. In other words, the RFID modules 100-400 according to the disclosure may switch between the reader mode and the transponder mode.

To sum up, the RFID module is provided in the disclosure. The identification module is disposed on the substrate and within the predetermined region. The predetermined region is surrounded by the antenna coil. The multiple connection points are disposed on the substrate and within the predetermined region. Also, the multiple connection points are disposed between the identification module and the antenna coil, or outside the predetermined region. Therefore, according to the disclosure, the size of the RFID module is reduced, the antenna loss is minimized, and the field shape of the antenna is improved. Furthermore, a user may read information stored in the external identification chip by the processor in the cellular phone, and the external reader directly reads its information in the identification module of the RFID module.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the disclosure pertains without departing from its spirit and scope. Accordingly, the scope of the disclosure is defined by the appended claims rather than the foregoing description and the exemplary embodiments described therein.

1. A radio frequency identification (RFID) module, comprising:
a substrate;
an antenna coil disposed on the substrate;
an identification module disposed on the substrate and in a predetermined region surrounded by the antenna coil, and electrically connected to the antenna coil; and
a plurality of connection points disposed on the substrate and electrically connected to the identification module, and a power pin, a ground pin, a data transmission pin, and a signal input/output pin of a control chip of a handheld electronic device; and
wherein the RFID module is switchable between a reader mode and a transponder mode.

2. The RFID module according to claim 1, wherein the connection points are pin pads.

3. The RFID module according to claim 1, wherein the connection points are located between the antenna coil and the identification module.

4. The RFID module according to claim 1, wherein the connection points are outside the predetermined region in which the identification coil is placed.

5. (canceled)

6. The RFID module according to claim 1, wherein the substrate comprises a first surface and a second surface opposing to the first surface, with the identification module is selectively placed on either the first surface or the second surface.

7. The RFID module according to claim 1, further comprising a connection circuitry disposed on the substrate and electrically connected to the antenna coil and the identification module.

8. The RFID module according to claim 1, wherein the antenna coil is an RFID antenna or a near-field communication antenna, and the substrate is a flexible substrate.

9. The RFID module according to claim 1, further comprising an interface bus having a first end and second end, wherein the first end is electrically connected to the connection points and the second end is connected to a power pin, a ground pin, a data transmission pin, and a signal input/output pin of a control chip of a handheld electronic device.
